(19) United States
(12) Patent Application Publication
(10) Pub. No.: US 2022/0207356 A1
(43) Pub. Date: Jun. 30, 2022

(54) NEURAL NETWORK PROCESSING UNIT WITH NETWORK PROCESSOR AND CONVOLUTION PROCESSOR

(71) Applicant: QUOPIN CO., LTD., Seongnam-si (KR)

(72) Inventors: Kyeong Soo KIM, Seongnam-si (KR); Sang Hoon LEE, Seongnam-si (KR)

(73) Assignee: QUOPIN CO., LTD.

(21) Appl. No.: 17/334,349

(22) Filed: May 28, 2021

(30) Foreign Application Priority Data
Dec. 30, 2020 (KR) 10-2020-0187144

(51) Int. Cl. G06N 3/08; G06F 17/16; G06N 3/063; H04L 29/06

(52) U.S. Cl. CPC G06N 3/08; H04L 69/161; G06N 3/063; G06F 17/16

(57) ABSTRACT

A neural network processing unit for a device according to the present invention includes an AV input matcher that receives a video signal or audio signal input from the outside; a convolution computation controller which receives and buffers the video signal or audio signal from the AV input matcher, divides the video signal or audio signal into overlapping video segments according to a size of a convolution kernel, and transfers the divided data; a convolution computation array which consists of a plurality of arrays, performs independent convolution computations for each divided video block by receiving the divided data, and transfers the results; an active pass controller which receives feature map (FM) information as convolution computation results from the plurality of convolution computation arrays to transfer the FM information to the convolution computation controller again for subsequent convolution computations or perform activation determination and pooling computation on a neural network structure; and a network processor for generating IP packets and processing TCP/IP or UDP/IP packets to transfer the FM as the convolution computation result to a server through a network and a control processor for installing and operating software for controlling configuration blocks. According to the present invention, the neural network processing unit for the device has an effect of reducing computation loads of the server by directly performing the distributed convolution operations in the device.

### CROSS REFERENCE TO RELATED APPLICATION

This application claims priority to and the benefit of Korean Patent Application No. 10-2020-0187144, filed on Dec. 30, 2020, the disclosure of which is incorporated herein by reference in its entirety.

### TECHNICAL FIELD

The present invention relates to a convolution neutral network (CNN) for a device, and more particularly, to a neural network processing unit for a device capable of reducing computation loads of a server by directly performing distribute convolution computations in a device and transmitting intermediate computation results to a server connected to the network without a latency with a network processor.

### BACKGROUND ART

Currently, artificial intelligence (AI) technology has been utilized in all industries such as autonomous vehicles, drones, artificial intelligence secretaries, and artificial intelligence cameras to create new technological innovations. The AI has been evaluated as a key driver of triggering the fourth industrial revolution, and the development of the AI has affected social systems as well as changes in industrial structure through industrial automation. As the industrial and social impacts of the AI technology are increasing and the demand for the development of services using the AI technology is increasing, the AI is equipped with various apparatuses or devices and the apparatuses or devices are connected to a network and organically operate with each other. As a result, there is a need for standardizing the technology related to distributed operations associated with the network.

An artificial neural network for deep learning consists of a training process for learning a neural network by receiving data and an inference process for performing data recognition with the learned neural network.

To this end, a convolutional neural network (CNN) commonly used as an AI network algorithm may be largely classified into a convolution layer and a fully connected layer, and in the two classified attributes, a computation amount and memory access characteristics are worlds apart with each other.

The convolution computation in the convolution layer consisting of multiple layers has a large computation amount enough to account for 90% to 99% of the total neural network computation amount. On the other hand, in the fully connected layer, the used amount of parameters, that is, weight parameters of the neural network is significantly more than that of the convolution layer. The weight of the fully connected layers in the entire artificial neural network is very small, but the amount of memory access is large enough to account for most of the weight, and eventually, memory bottlenecks occur, causing performance degradation.

However, most of AI processors developed for AI applications have been developed for target markets, such as edge-only or server-only. Large-capacity data sets and large resources are input to perform long learning processes, and when AI processors for servers used in a wide range of applications perform inputting and storing various data sets, convolution processing by receiving the input and stored data sets, and learning and inference processes using calculated computation results, a large scale of resources need to be built. Approach using a large-capacity server has been invested mainly in global portal companies such as Google, Amazon, and Microsoft.

For example, in a voice signal, Open AI, a non-profit company, has released resources for learning GPT-3 (Open AI Speech dataset), which contains 175 billion parameters, 10 times more than existing neural network-based language processing models. The number of data used for learning is 499 billion, and it requires a huge amount of resources for learning. The total cost required for learning is known as about USD 4.6M.

Accordingly, in the present invention, beyond a method of performing all learning and inference by storing all resources in any one point, all data sets are distributed and processed in the devices, and the calculated data are mutually transmitted to packets with promised data structures to prevent the all resources from being concentrated and constructed in the server.

Unlike a central server-concentrated method, for artificial intelligence used at an edge end around a portable device or user, the present invention is applied as a technique for storing a CNN structure as simple as possible and the number of parameters as small as possible. In the CNN, since a lot of computation costs are required, many companies are actively developing mobile and embedded processor architectures to reduce neural network-based inference time at high speed and low power. Instead of having a little low inference accuracy, it is designed to use relatively low-cost resources.

Accordingly, in this material, a part for convolution preprocessing is implemented in each distributed device and preprocessed in a convolution means equipped on each device, calculated feature maps and convolution network (CNN) structure information, and main parameters are converted to a standardized packet structure to be transmitted to the server. The server performs only a function of learning and inference by using preprocessed convolution calculation results and main parameter values. Accordingly, it is possible to avoid all resources from being concentrated on the server, and it is possible to improve processing performance and speed by utilizing calculated values in distributed devices. Of course, a network latency that mutually transmits calculated values every middle is taken, but in a Standalone 5G network coming in the future, the transmission latency is about 1 ms (mili-second), which is at an ignorable level.

In the meantime, while performing artificial neural network computations using GPU in most academia and industry at the same time as the development of CNN, research has also been actively conducted for the development of hardware accelerators dedicated to artificial neural network computations. The main reason why the GPU is widely used in deep learning is that the key computations used in deep learning are very suitable for using the GPU. Currently, the most commonly used computation in image processing deep learning is an image convolution computation, which can be easily substituted with a matrix multiplication computation with very high performance on the GPU. A Fast Fourier Transform (FFT) computation used to accelerate the image convolution is also known to be suitable for the GPU.

However, since the GPU is excellent in terms of program flexibility, but GPU price is too high to be mounted on every device and cannot be mounted on all devices that require AI, it is required to develop a dedicated processor for convolution processing at an application-appropriate level.

As a result, in the present invention, for artificial neural network computations, it is focused to develop a dedicated accelerator with excellent computation performance against energy than the GPU. In addition, the present invention is to develop and apply a convolution processing device applicable even to low-cost devices.

Furthermore, the present invention is to a device chip consisting of an input conversion unit converting images or audios to a structure suitable for a matrix multiplication according to a signal feature when inputting the images or audios, CNN and RNN processing arrays, and network processors which perform IP packetization processing of calculation results and a low-latency transmission function.

### PRIOR ARTS

[Patent Document]
(Patent Document 1) Korean Patent Publication No. 10-2020-0127702 (published on Nov. 11, 2020)

[Disclosure]

### Technical Problem

Therefore, the present invention is derived to solve the problems, and an object of the present invention is to provide a neural network processing unit for a device and to reduce computation loads of a server by directly performing distributed convolution computations in the device.

To this end, there is a need to have a convolution array with a circuit configuration optimized so as to be easily mounted on the device, and it is required a dedicated network processor for IP packetization processing of intermediate convolution computation results, and processing and transmission of packet configurations for transmission to a network-side server at high speed and low-latency.

The present invention is to provide a neural network processing unit for a device having a convolution processor array and a multiple network processor.

However, technical objects of the present invention are not restricted to the technical objects mentioned as above, and other unmentioned technical objects will be apparently appreciated by those skilled in the art by referencing the following description.

### Technical Solution

According to an embodiment of the present invention, there is provided a neural network processing unit for a device including: an AV input matcher that receives a video signal or audio signal input from the outside; a convolution computation controller which receives and buffers the video signal or audio signal from the AV input matcher, divides the video signal or audio signal into overlapping video segments according to a size of a convolution kernel, and transfers the divided data; a convolution computation array which consists of a plurality of arrays, performs independent convolution computations for each divided video block by receiving the divided data, and transfers the results; an active pass controller which receives feature map (FM) information as convolution computation results from the plurality of convolution computation arrays to transfer the FM information to the convolution computation controller again for subsequent convolution computations or perform activation determination and pooling computation on a neural network structure; and a network processor for generating IP packets and processing TCP/IP or UDP/IP packets to transfer the FM as the convolution computation result to a server through a network and a control processor for installing and operating software for controlling configuration blocks.

### Advantageous Effects

According to the present invention, the neural network processing unit for the device has an effect of reducing computation loads of the server by directly performing the distributed convolution computations in the device.

Further, according to the present invention, it is possible to define an overlapping structure for parallel computations according to an input resolution and a convolution kernel size, and improve a computation speed by allowing simultaneous processing of the results of parallel computations.

Furthermore, according to the present invention, the independent convolution computation array and the audio matrix computing unit are separately configured to process simultaneously the input image and the audio information to be separated and simultaneously fuse the artificial processing for the image and the audio. Accordingly, the present invention is applicable to a variety of inter-linked applications of video and audio in the future.

### DESCRIPTION OF DRAWINGS

FIGS. 1A-1B illustrate examples of comparing cloud AI and edge AI and configuring a neural network.

FIG. 2 is a schematic diagram of distributed artificial intelligence (AI) according to an embodiment of the present invention.

FIG. 3 is a flowchart for a distributed AI learning procedure according to an embodiment of the present invention.

FIG. 4 is a diagram illustrating a convolution processing method for one sheet of image according to an embodiment of the present invention.

FIG. 5 is an embodiment of convolution 2-divided parallel processing according to an embodiment of the present invention.

FIG. 6 is an embodiment of convolution 2-divided parallel time difference processing according to an embodiment of the present invention.

FIG. 7 is an embodiment of convolution 4-divided parallel processing according to an embodiment of the present invention.

FIG. 8 is a configuration diagram of (X, Y) resolution support (m×n) convolution separation according to one embodiment of the present invention.

FIG. 9 is a detailed configuration diagram of a CNN processors array according to one embodiment of the present invention.

FIG. 10 is a detailed configuration diagram of a convolution element according to one embodiment of the present invention.

FIG. 11 is a convolution processing unit for a device for distributed AI according to one embodiment of the present invention.

FIG. 12 is a distributed AI accelerating unit which enables audio/video simultaneous processing according to one embodiment of the present invention.

FIG. 13 is a detailed configuration diagram of RNN processors according to an embodiment of the present invention.

FIG. 14 illustrates an optimization computing unit which computes machine learning for time series data with dependency at the same time as an audio or voice in the distributed AI accelerating unit which enables audio/video simultaneous processing in FIG. 12.

FIG. 15 illustrates the same recurrent neural network (RNN) and a basic state transition diagram of the RNN.

### [Modes for the Invention]

Advantages and features of the present invention, and methods for accomplishing the same will be more clearly understood from exemplary embodiments described in detail below with reference to the accompanying drawings. However, the present invention is not limited to the embodiments set forth below, and may be embodied in various different forms. The present embodiments are just for rendering the disclosure of the present invention complete and are set forth to provide a complete understanding of the scope of the invention to a person with ordinary skill in the technical field to which the present invention pertains, and the present invention will only be defined by the scope of the claims.

Like reference numerals refer to like elements throughout the specification.

Hereinafter, a convolution processor for a device according to an embodiment of the present invention will be described with reference to the accompanying drawings.

At this time, each block of processing flowchart drawings and combinations of flowchart drawings will be understood to be performed by computer program instructions.

Since these computer program instructions may be mounted on processors of a general-purpose computer, a special-purpose computer or other programmable data processing devices, the instructions executed by the processors of the computer or other programmable data processing devices generate means of performing functions described in block(s) of the flowchart.

Since these computer program instructions may also be stored in computer-usable or computer-readable memory that may orientate a computer or other programmable data processing devices to implement a function by a specific method, the instructions stored in the computer-usable or computer-readable memory may produce a manufacturing item containing instruction means for performing the functions described in the block(s) of the flowchart.

Since the computer program instructions may also be mounted on the computer or other programmable data processing devices, a series of operational steps are performed on the computer or other programmable data processing devices to generate a process executed by the computer, so that the instructions performing the computer or other programmable data processing devices can provide steps for executing the functions descried in the block(s) of the flowchart.

Further, each block may represent a part of a module, a segment, or a code that includes one or more executable instructions for executing a specified logical function(s). It should also be noted that in some alternative embodiments, the functions mentioned in the blocks may occur out of order. For example, two successive illustrated blocks may in fact be performed substantially concurrently or the blocks may be sometimes performed in reverse order according to the corresponding function.

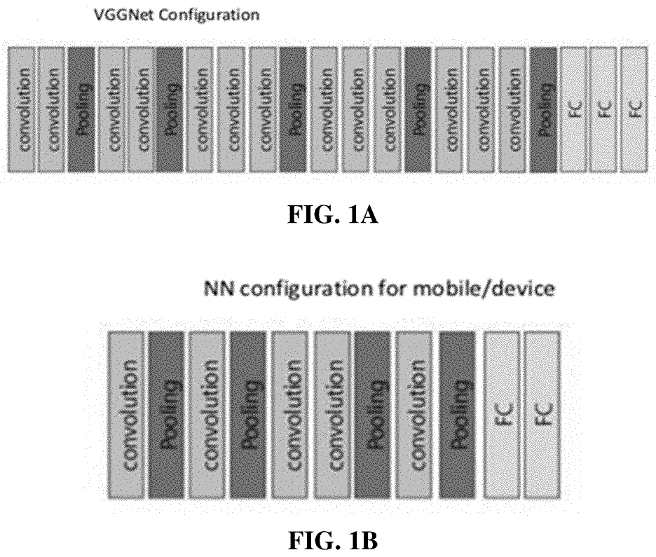

FIGS. 1A-1B illustrate examples of comparing cloud AI and edge AI and configuring a neural net (neural network). In 2012, Krizhevsky proposed a simple CNN called AlexNet in the paper “ImageNet Classification with Deep Convolutional Neural Networks” disclosed in The Proceedings of the 25th International Conference on Neural Information Processing Systems (Lake Tahoe, NV Dec.2012, P. 1097-1105.).

Technology using a convolution neural network (CNN) had far better performance improvement than an image classification method used in conventional image processing technology. At that time, the learning was performed for 6 days using two Nvidia Geforce GTX 580 GPUs, and (11×11), (5×5), (3×3), five convolution layers and three fully connected layers were used. The AlexNet has 60 M (60 million) or more of model parameters and requires a 250 MB storage space for storage with a 32-bit floating-point format.

Thereafter, in the oxford university, as illustrated in FIG. 1A, in VGGNet, a recognition rate was significantly improved by using total 16 layers consisting of 13 (3*3) convolution layers and three fully connected (FC) layers. With the development of GoogleNet/Inception, ResNet, etc. proposed in Google over the years, there is provided performance that surpasses human recognition abilities by increasing the depth of the convolution layer from dozens to hundreds, and the performance has been developed from various angles by finding that the performance is excellent and the number of parameters may be reduced by overlapping and using kernels smaller than larger size kernels.

FIG. 1B illustrates a neural network simplified to be mounted on a simple terminal device even if the recognition performance is slightly reduced as compared with a complex neutral network structure in a simple device, etc. However, since learning and inference tools are integrated and mounted in a single device, both the configurations independently perform the AI processing. In this case, in the independent device, since huge-capacity memories that store a learning data set and store computations for convolution computation processing and classification of fully connected layers, intermediate calculations values thereof, and a feature map need to be all maintained, the costs rapidly increase.

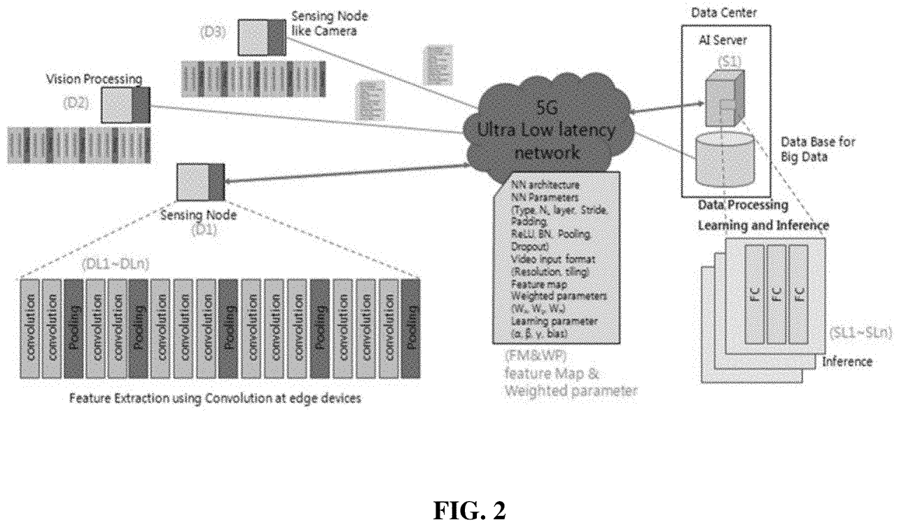

FIG. 2 is a schematic diagram of distributed artificial intelligence (AI) according to an embodiment of the present invention.

A convolutional neural network (CNN) used for deep learning is largely divided into convolution layers and fully connected layers, wherein a computation amount and memory access characteristics are inconsistent with each other. The convolution computation in the convolution layer consisting of multiple layers has a large computation amount enough to account for 90% to 99% of the total neural network computation amount. Therefore, measures are required to reduce convolution computation time. On the other hand, in the fully connected layer, the used amount of parameters, that is, weight parameters of the neural network is significantly more than that of the convolution layer. The weight of the fully connected layers in the entire artificial neural network is very small, but the amount of memory access is large enough to account for most of the weight, and eventually, memory bottlenecks occur, causing performance degradation. Accordingly, there may be provided more advantages than an effect by a network latency by distributing two blocks having different characteristics according to a characteristic instead of collecting the two blocks in one device or server. In a 5G network coming in the future, since a network transmission latency is within several ms, distributed AI technology is likely to be more likely to be utilized.

As illustrated in FIG. 2, when receiving a video signal or audio signal from many devices D1 to D3 connected on a communication network, a convolution means mounted on the device pre-processes the received video signal or audio signal, converts a calculated feature map (FM), convolution network (CNN) structure information, a weighting parameter (WP) to a standardized packet structure, and transmits packets to a server S1 according to communication rules promised between a plurality of devices D1 to D3 and a central server S1. The server S1 performs comprehensive learning and inference operations by using the feature map (FM) information and the weighting parameter (WP), which are convolution calculation result values pre-processed in each of the distributed devices D1 to D3.

The server S1 repeats a process of transmitting and updating each of the parameters for a structure of each updated neural network to each of the devices D1 to D3 again and then the learning is completed. When the learning is completed, a weighting parameter, etc. of a final neural network are defined, and then video/audio information is input, in each of the devices D1 to D3, an internal convolution processing means extracts features and transmits the extracted feature map to the server S1 at an ultra low latency, and the server S1 may determine comprehensively the transmitted feature map.

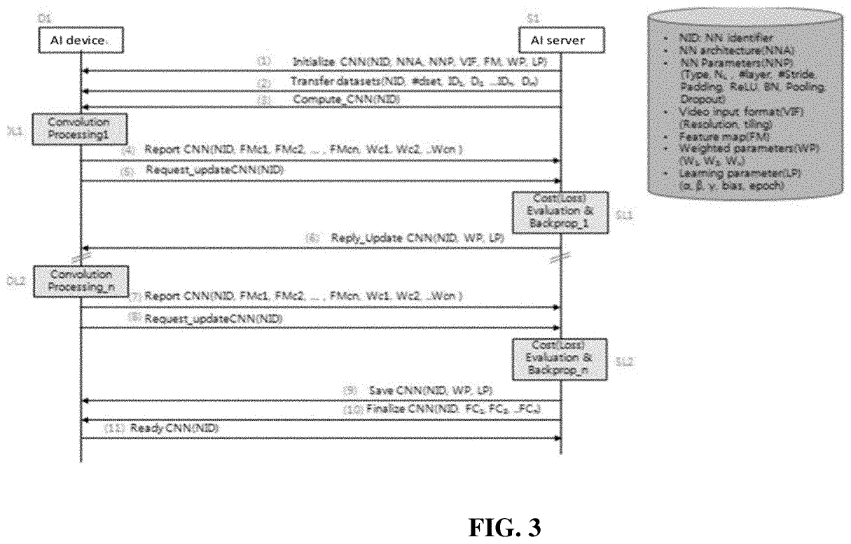

FIG. 3 is a flowchart for a distributed AI learning procedure according to an embodiment of the present invention.

An AI cloud server S1 sends an Initialize CNN message 1 to an AI device D1 connected to the network. When this message is received, the device D1 initializes holding CNN-related parameters to a value specified by the server. The following parameters are included in this message.
Network Identifier (NID, granting CNN network id): Recognition identifier of network
Neural Network Architecture (NNA): Identifier for pre-defined NN structure
Neural Network Parameter (NNP): Specify setting values for actual components involved in the neutral network, such as Network id (NID), CNN Type (CNN configuration information, convolution block, etc.), NL (meaning the total number of layers, meaning the Hidden Layer number+1), #layer (the number of layers in a convolution block), #Stride (the stride number during convolution processing), Padding (presence or absence of padding), ReLU (activation function), BN (batch normalization related designation), Pooling (pooling-related parameter), Dropout (parameters related to drop-out method), etc.

The server transfers a transfer datasets (NID, #dset, ID₁, Dᵢ₁ . . . IDₙ, Dᵢₙ) message 2 to each device for pre-processing convolution computations for learning to perform distributed convolution processing other than an integrated computation. The server transfers different data sets to each device to process the convolution computation.

To this end, the server side transmits each network identifier (NID), the total number #dset of data sets, and data sets required for learning, and data sets Di1 to Din together with a data identifier Idi (I=1, to n). Each dataset transfers image data according to a predetermined resolution size. It is not necessarily limited to the image data, and other two-dimensional data or one-dimensional voice data are also possible.

When receiving a Compute CNN message 3 after receiving a data set from the server, each device performs convolution computation processing in an accelerating unit consisting of a means set for a convolution computation DL1 and a convolution array. The device performs a convolution computation, an activation computation such as ReLU, and a pooling computation.

When finishing a series of convolution computations, the corresponding device D1 sends a message 4 Report CNN (NID, FMc1, FMc2, . . . , FMcn, Wc1, Wc2, . . . Wcn) to the server. The corresponding neutral network identifier and the feature map and weighted parameters of each corresponding convolution layer are transferred to the server together. When the corresponding information transmission is finished, the device D1 sends a request message Request Update 5 for updating the corresponding CNN. Then, the server S1 performs the computation processing of the fully connected layer for inference by using the convolution computation results computed so far, calculates a predefined Cost function (Loss function) by using the results thereof, and performs an operation of correcting each parameter by a learning parameter. Thereafter, the server replies (6) information to update the updated weighting parameter WP and the learning parameter LP to each device side. Such a batch operation is continuously repeated. Processes of messages 7 and 8 are repeated and the batch computation stops when the predefined Cost function is closer to a minimum value (the Loss function is a minimum value 0).

After the final learning is terminated, the server sends a Save CNN (NID, WP, LP) message 9 to each device and transmits and stores the finally updated weighting parameter WP and learning parameter LP. In addition, the server sends a Finalize CNN (NID, FC₁, FC₂, FCₙ) message 10 and transmits FC₁, FC₂, . . . FCₙ as WP of the fully connected layer computed in the fully connected layer to complete parameters of the final neural network. The device receiving the message stores parameters of WP, LP, and FC transmitted from the server to an internal memory. Thereafter, when the input audio/video signal is received, a convolution computation is performed by using the corresponding weighted parameters to perform a task to determine an object of each input. The above parameters are for one embodiment, and are variable according to the development of various convolution neutral networks.

The CNN processor array can usually implement convolution computations as a systolic array used in most matrix computations. However, in the present invention, a configuration based on a basic matrix multiplier was considered.

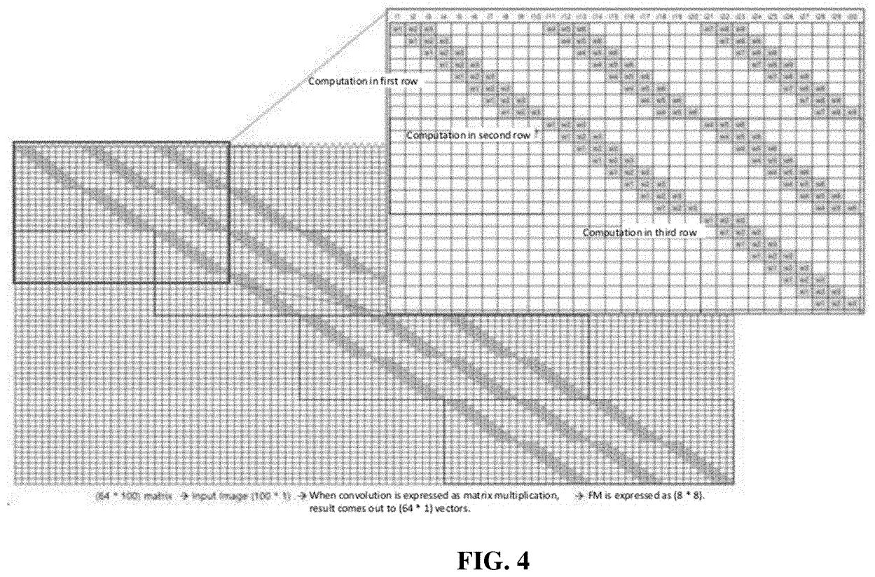

In FIG. 4, in the case of continuous video input of 60 frames per second, it helps the understanding that a processing method for a convolution computation on a sheet of image was unfolded into matrix multiplication. An embodiment is when assuming that the resolution of one sheet of video image to be actually input is (10×10). When (10×10) images are unfolded in a line, the images have a total of 100 pixel values. When convolution kernel parameters are assumed as (3×3) by receiving pixel columns to be input in a line, it can be seen that 9 parameters are illustrated as 1D of a series of pixels and pixel-by-pixel multiplication, and sequentially computed as illustrated in FIG. 4. While convolution kernels (3×3) move from left to right along each first row, the convolution computations are performed. After the computation is completed along one row, for a convolution computation for a next row, it is represented as a next second red box when moving to a first column. As such, the motion of the kernel (filter) of the convolution computation is expressed in (64×100) as a matrix.

When (64*100) matrix and Input Image (100*1) are expressed as a matrix multiplication, a matrix multiplication result comes out to (64*1) vectors. This 2D feature map (FM) is represented by (8*8). However, for packetization processing for actual network transfer, instead of a 2D concept, data aligned in a 1D line is implemented to be packetized in a pipeline manner. Since there are a lot of element parts of actual 0 when implemented in the matrix multiplication form of FIG. 4, it is possible to waste unnecessary memory space. If the actual convolution kernel is (3×3), when an input pixel matrix is input, 9 multipliers and a computer of adding the 9 multipliers are just required. Therefore, the present invention can be implemented only by 9 registers storing weighting vectors of the (3×3) convolution kernel, a register selecting and storing 9 input pixel matrixes, 9 multipliers, an adder adding the results, and a register storing the results.

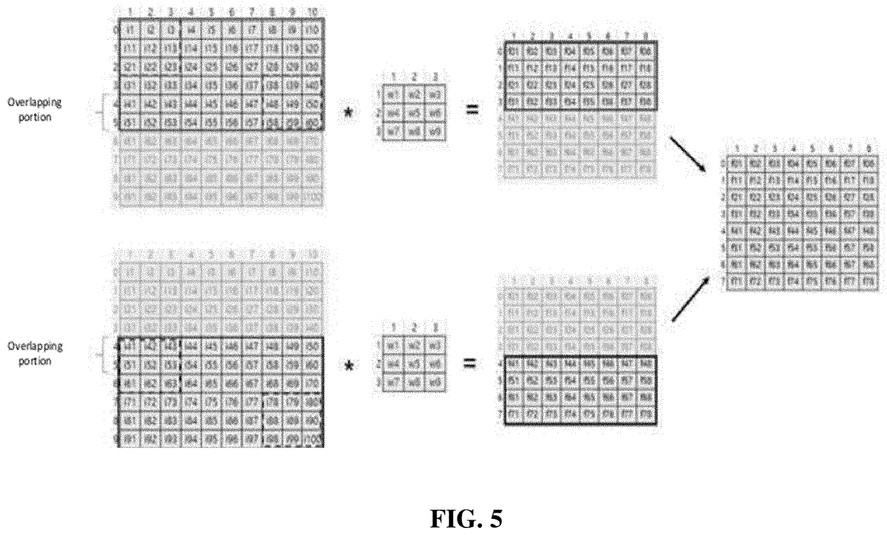

To process continuous frame images with pipeline computations in real time, a plurality of convolution computers are configured in parallel and a simultaneous processing structure is required. To this end, FIG. 5 illustrates a method in which a virtual (10×10) image is divided by two convolution computers. For (3*3) convolution processing, at least two lines are overlapped and used to be simultaneously processed. When a (10×10) image is divided into two (6×10) images to divide two upper and lower parts, it can be seen that two convolution computations can be processed at the same time. If the kernel filter is increased instead of (3*3), the overlapping portion should also be increased. However, as a result of many studies, since it is more advantageous to repeatedly apply small filters rather than an increase in the number of kernel filters, this embodiment was limited to (3×3).

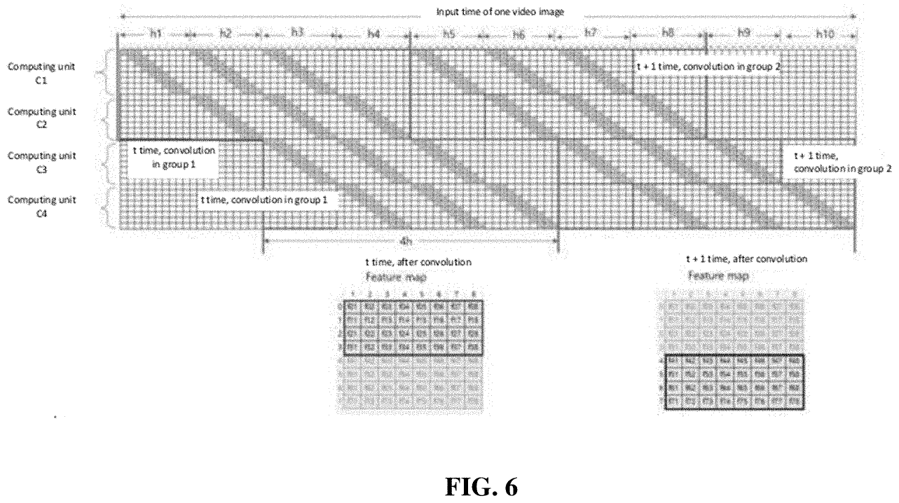

In FIG. 6, it is illustrated for a two-division parallel time difference processing to be divided and convoluted by ½ of the video resolution. The convolution computing unit has one output value for three lines for each input horizontal line to be divided into four computers for parallel computation according to an output. In one computer, when any one image for all videos in a horizontal line column to be input is (10×10), if the total image input time is T by considering an order to be input in a line, a horizontal line corresponding to each row is divided into 10 parts and each row requires a time of h1. In the case of the (3×3) convolutional kernel, at least two video horizontal lines and three pixel values of a third horizontal line need to be input to be multiplied for each pixel. Then, when all three horizontal lines are input, the feature map makes a row as a convolution result. The adjacent computer 2 performs computations for h2 to h4 to calculate a next row of the features map. Then, when the input video is divided into two groups horizontally and 6 horizontal lines input for each group all are input, the computations of Group A are finished and the convolution computation of Group B is completed when the inputs from h5 to h10 is completed. A computer C1 performs the computation of Group 2 for a (t+1) time interval immediately after calculating the result of the first line. As such, when the computation is performed in a pipeline manner, even if the continuous videos are input, a continuous computation process is enabled after a predetermined latency.

Actually, according to a CNN network structure, the convolution computation repeats the batch operation to obtain the feature map with a smaller resolution through convolution and ReLU activation computations and a pooling process. In order to perform the convolution computation repeatedly, it is important to configure at least this convolution computer array and parallelize the convolution computer array to enable the continuous repeated computation. In addition, the resolution size of the video is increased or it is required to organically manage the convolution array depending on a frame per second (FPS). If the resolution of the video is increased, the convolution array is divided into a horizontal group and a vertical group and processed in parallel, so that a convolution array control method is used to be able to be processed for this.

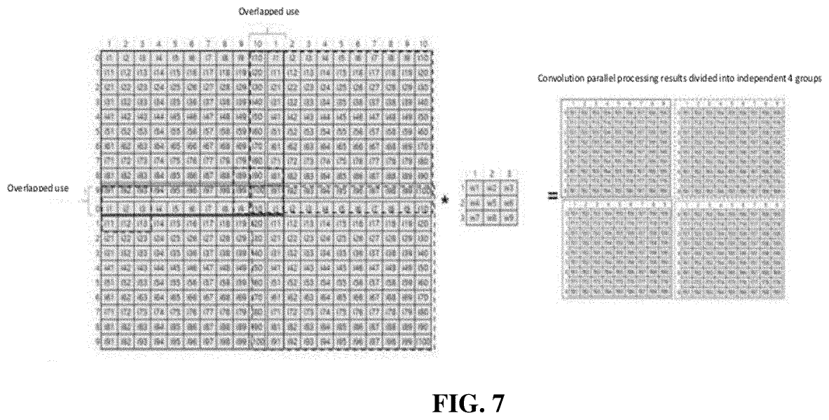

FIG. 7 is a schematic diagram of dividing the entire video into four groups and processing in parallel in the case of a video having a large resolution. The video is divided into ¼ and each is merged after convolution processing. Even in this case, if the convolution kernel is (3×3), two horizontal/vertical lines are overlapped and divided. In the case of an actually used high resolution such as FHD (resolution of 1920×1080) and UHD (resolution of 3840*2160), the video resolution is much larger than a resolution of various data sets used in AI such as existing video/audio, etc. Then, preprocessing for extracting an object is performed by applying the convolution to an input of a standard video, a given algorithm is performed, and then is will be required to normalize a finding object at the same video size as the data set.

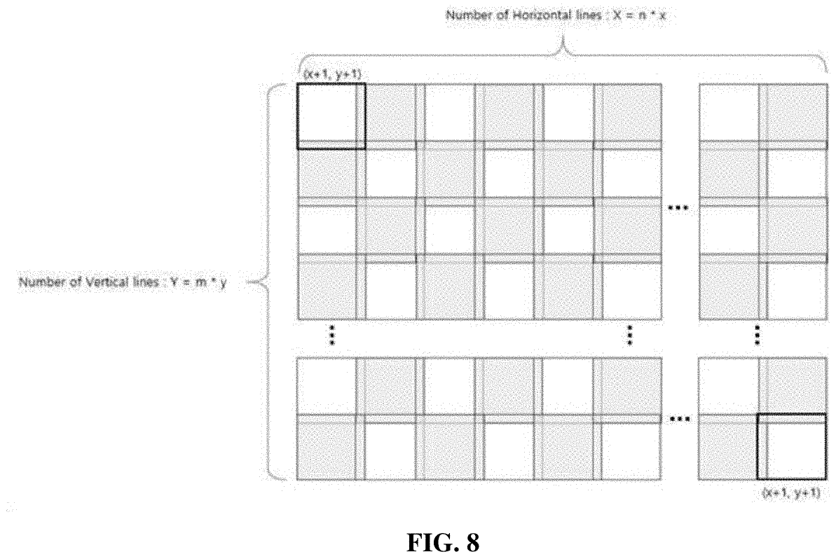

FIG. 8 illustrates a method of dividing the video into a plurality of videos by using two overlapping lines during the (3×3) convolution processing when a general video resolution is large.

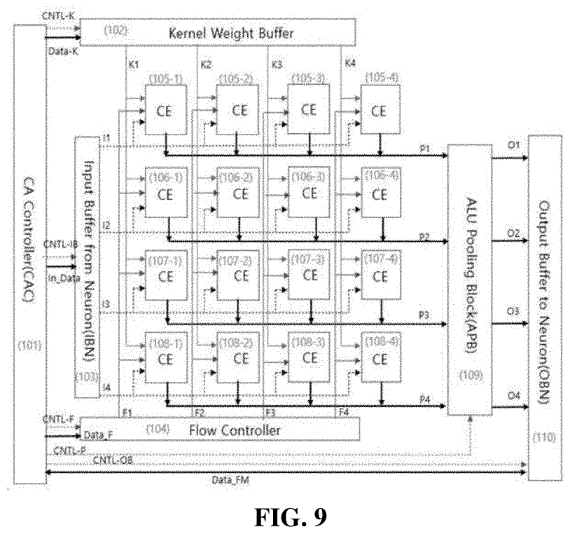

FIG. 9 illustrates a block configuration for implementing a convolution computer array. In the embodiment of the present invention, an embodiment of a (4×4) convolution array was illustrated. In the actual implementation, much more arrays (m, n) are configured and implemented to be various operated according to various video sizes to be input and a structure of a CNN network. A convolution array controller (CAC) 101 of FIG. 9 reads a weighting parameter (WP) value as a kernel filter value used for a convolution computation stored in an external memory and stores the WP value in a kernel weight buffer (KWB) 102. Thereafter, the KWB 102 transfers all of (3×3) 9 values to all convolution elements 105-1 to 105-4, 106-1 to 106-4, 107-1 to 107-4, and 108-1 to 108-4 through each corresponding line K1 to K4 to use the values as a weight parameter of the kernel during the convolution computation. Unlike this, in pixel columns of the input video, the CAC 101 reads one image of images with resolutions stored in an external buffer and temporarily store the read image in an input buffer from neuron (IBN) for each horizontal line divided into a predetermined size unit (in the present embodiment, x+1) through a CNTL-IB control signal and an In Data bus. The IBN 103 inputs a segment video with a size of (x+1, y+1) considering an overlapping portion to a video tile consisting of (x, y) as each convolution element (CE) through serial lines I1 to I4 according to each corresponding row/column.

Thereafter, in the control of an independent convolution computation of each convolution element CE, when the CAC 101 stores predetermined computation timing information in the flow controller 104 through a control signal CNTL-F and data Data_F according to a size of the corresponding video segment, the FC 104 generates timing information F1 to F4 of each convolution element to control the convolution computation of each CE. As the result computed in each convolution element, when each result of the matrix multiplication and the addition is sequentially received through signal lines P1 to P4, an ALU pooling block 109 generates and stores a feature map as a convolution computation result for the entire image. As illustrated in FIG. 2, according to a neural network structure, in some cases, when continuous convolutions are repeated without a pooling computation, the APB 109 is bypassed and Data FM is fed-back to an original input terminal again through an output buffer to neuron (OBN). After the convolution computation, when the pooling computation for reducing the resolution of the video again is required, the APB 109 performs a pooling computation according to a given pooling standard (stride, pooling method) such as a maximum value selection method using a (2, 2) window in the feature map as the previous computation result.

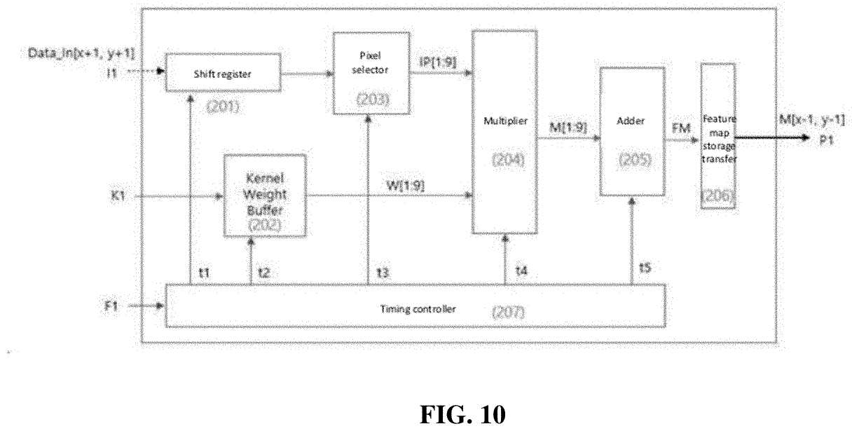

In FIG. 10, an embodiment for each convolution computation element illustrated in FIG. 9 was expressed. Like the embodiment, in the case of using the (3×3) convolution kernel, 9 convolution kernel weights 202 and 9 pixel values of pixels of the input image are selected (203) and mutually multiplied (204). After multiplication, 9 multiplication results are added (205) to each other. A kernel weight buffer 202 is a buffer of storing a weight vector value of the convolution kernel as described above. This buffer is a place of storing a kernel weight value to be used in the device by using information in a packet to be transferred to the server side. This buffer inputs 9 weight values to the multiplier in parallel through a signal W[1:9]. Simultaneously, in the feature map as the result of the previous convolution computation to be input or the corresponding video segment information of the images of the input video, Data_In[x+1, y+1] data is received through a serial I1 signal and a pixel value to be applied to the convolution is extracted by using a shift register 201 for extracting the corresponding pixel value. When receiving the extracted pixel value, a pixel selector inputs 9 parallel data IP[1:9] to the multiplier and the multiplier 240 performs a multiplication computation of weights W[1:9] and IP[1:9] to each other. The multiplier 204 performs W1*IP1, W2*IP2, W9*IP9 for each digit, respectively, and the adder 205 adds the result M[1:9]. As the result, the feature map (FM) can generate an FM vector when collecting each result by moving a position of each row. There is a block 206 which collects these result values and organizes and stores the values as a vector, and transfers an output. There is a timing controller 207 for controlling an operation time for each entire detailed configuration.

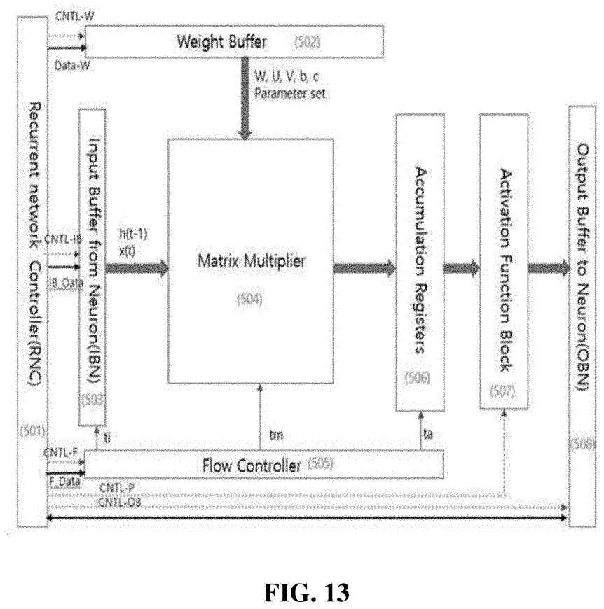

In the case of the convolution processing for the 2D video or image described above, since a spatial relationship is maintained between pixels configuring the image, between vertical/horizontal adjacent pixels, the convolution computation is very appropriate to find a main feature point to be included. However, since the voice or audio signal is a 1D signal of changing according to a time axis, the signal has no relationship of spatial adjacent values, and as a result, there is a difference from the convolution computation so far. These 1D signals have a meaning in relevance to adjacent times, such as speech content or linguistic meaning at the given time, so a different approach scheme is required. A separate computer for this is proposed in FIG. 13.

Actually in a device which receives a video such as intelligent CCTV and performs AI processing, an original video is directly transferred to a server side and a cloud server performs all computations required for using for learning and situation recognition. In addition, when occurrence of any event is detected, a video recording function for storing the input video on the server is required. However, in the case of most of IP CCTV cameras, the camera itself compresses and transmits a video and the server has a function of decoding the compressed video again. Such a device is equipped with a codec, but has an external application processor to process IP packetization in an application software manner mounted in the processor and then streams a RTP/UDP/IP or RTP/TCP/IP packet and transmits the packet to the server. Then, an end-to-end transfer latency through a network requires 0.5 to 1 sec or more. In the related art, as compared with a time such as video compression transfer, etc., since a network transfer latency is dominant, compression latency/packet transfer performance, transmission latency, etc. were not greatly interested. However, in a 5G network of a standalone (SA) scheme to come in the future, since the transmission latency is 1 ms, an ultra-low latency service is necessarily on the rise, and to this end, in a video input/processing device, an ultra-low latency video processing is required.

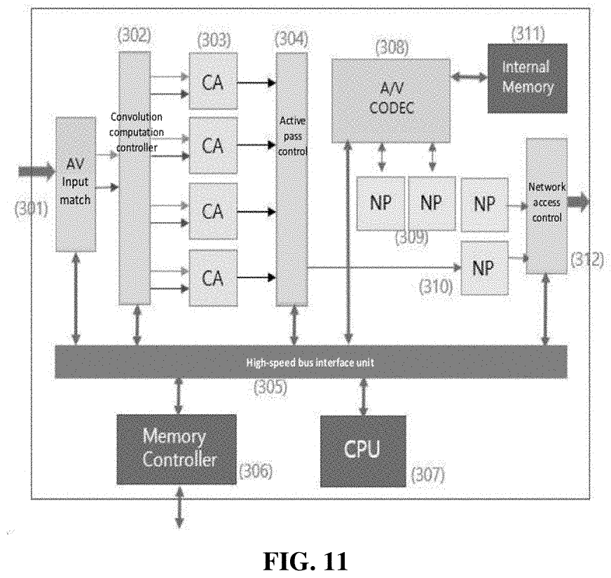

Then, in FIG. 11, the device of inputting the video is a distributed convolution processing unit including a function of transferring a video compressed in real time (ultra-low latency) by compressing a main video while performing the convolution computation. Actually, in a camera having a function of an intelligence CCTV, when inputting a video and an audio, if an object is detected from an edge terminal and abnormality thereof is immediately recognized and processed, many parts can be processed in real time.

Like an embodiment of a convolution processing unit for a device for distributed AI illustrated in FIG. 11, during video inputting, an AV input matcher 301 receives an input video/audio signal to transfer the received signal to a convolution computation controller 302 through a high-speed bus interface unit 305 or transfer the received signal to a memory controller for temporary storage, for normal processing by receiving an input according to a resolution size for each channel of R/G/B, etc. in the case of a video data. A system central control processor (CPU) 307 controls the signal in real time by a control program and a memory controller 306 may store the signal in an external memory. The convolution computation controller 302 performs a control/command/data control, etc. to buffer the video/audio signal to be input in real time. A plurality of arrays (CA) 303 for a plurality of convolution computations is configured, and performs independent convolution computations for each divided block. Thereafter, in order to feedback the result values to an input terminal again for repeated computations, the result values may be transferred to the convolution computation controller again through the high-speed interface unit 305, or after performing a nonlinear activation computation, the result can be transmitted to the server side through the network for the following procedure. This final control is performed in an active pass controller 304. In order to transfer the result with the server side through the network without a latency, the result is transferred to a network processor 310 to be particularly allocated, and feature map (FM) information as the convolution result as well as the weighting parameters are packetized and the packet is processed according to a protocol of TCP/IP, UDP/IP, or the like after processing an IP packet. In addition, in order to transfer one source of input video and audio information, an A/V CODEC 308 for H.264/H.265 compression computation and AAC compression of the audio is included, and an internal memory 311 for storing a frame unit is included to perform an algorithm for coding. In addition, to transfer the compressed video/audio information to the server side, for IP packet processing, a series of network processors 309 are used. As such, a plurality of separate network processors 309 are included and serve to control the transmission quality according to protocol stack processing for network IP communication, packetization processing, priority processing, and a network condition.

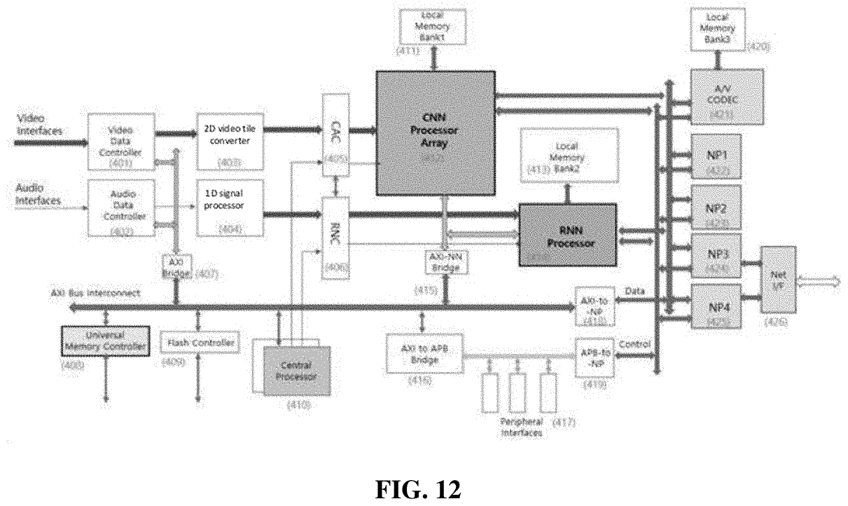

In FIG. 12, a detailed embodiment of a distributed AI accelerating unit for audio/video simultaneous processing is illustrated. In actual implementation, a main control processor is applied with a processor of ARM Corporation and an AMBA bus standard. Then, a multiple channel bus, an advance extensible interface (AXI) bus optimized for reading/writing and an advanced peripheral bus (APB) for connecting a peripheral interface at a relatively low speed are used, and AXI bridges 407, 415, 416, and 418 for bus separation are used.

A video signal input through a video input interface is converted into a data form for handling in a chip in a video data controller 401, and temporarily stored in an external memory by receiving a control of a universal memory controller 408 connected to a bus through the AXI bridge 407. Further, after the internal data is converted, an image for performing convolution is segmented into a plurality of tile forms and transferred to a 2D image tile converter 403 for image segment processing considering an overlapping part. Thereafter, image segments to be segmented are transferred to the CAC 405 for convolution processing. Like this, the voice or audio signal is received through an audio data controller 402 and temporarily stored in an external memory through the AXI bus like the video or transferred to a 1D signal processor 404 for RNC processing and segment processing for the time. Thereafter, the 1D processed audio data is transferred to a recurrent neural network controller 406 for RNN computation processing. Herein, a configuration and an operation of a CNN processor array 412 follow the contents described in FIGS. 9 and 10.

In addition, the RNN processor is described with reference to FIG. 13. The CAC 405 and the RNC 406 perform internal computations and local memory banks 411 and 413 dependent on each computer are used to store temporarily the results, etc. In order to transfer feature map information obtained as the result of each 2D convolution computation to the server through the network without a latency, network processors (NPs) NP3, 424, NP4, and 425, etc. perform IP packetization processing and perform a function of transferring TCP/IP and UDP/IP packets to the network side according to a required protocol stack. In addition, when a major event occurs or in order to transfer an original of the selected video or image, and a voice signal or audio signal file to the server side, an A/V CODEC 421 receives a control of a central control processor 410 and reads data stored temporarily in an external memory to the local memory bank3 420 through an AXI bud to perform coding processing. To this end, NP1 422 and NP2 423 separately allocated are included to control each audio and video codec in real time. A real-time compression algorithm equipped with relevant firmware is performed. When the compression is completed through such a series of processes, NP3, NP4, etc. perform network interface processing, and performs stably the communication with the server. In order to control a function of the overall chip and to use upper application software, a plurality of central processors 410 are included and managed. To this, a universal memory controller 408 is included to connect an external flash memory and an external normal DDR memory.

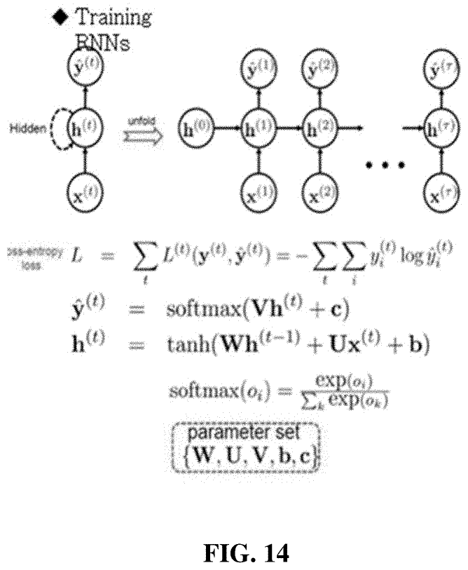

FIG. 14 illustrates an optimization computing unit which computes machine learning for time series data with dependency at the same time as an audio or voice in the distributed AI accelerating unit which enables audio/video simultaneous processing in FIG. 12.

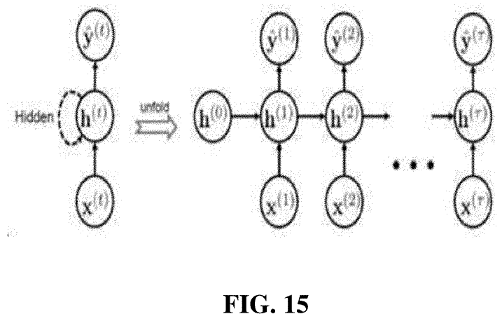

FIG. 15 illustrates the same recurrent neural network (RNN) and a basic state transition diagram of the RNN.

An output y∧^{(t)} represented in Equation 2 is determined by a weight V^{(t)} and an initial value C^{(t)} coupled with a state h^{(t)} of a hidden layer, wherein the highest probabilistic possibility value is taken by applying a softmax( )function value. Softmax normalizes all the input values to values between 0 and 1 as the output, and the sum of the output values means a function with a characteristic of always 1. Softmax has a similar meaning to probability.

The hidden state (hidden layer) h^{(t)} is determined in a relationship among a weight W^{(t)} combined with the previous state, a weight U^{(t)} of an input, and a constant b^{(t)}. The embodiment herein is determined by taking a nonlinear activation function tanh ( ) The relevant expression was shown in Equation 3.

$$\begin{matrix}\text{?} L = {\sum }_{\text{?}} L \text{?} ( y \text{?} , \dot{y} \text{?} ) = - {\sum }_{\text{?}} {\sum }_{\text{?}} y \text{?} log \dot{y} \text{?} & ( Equation 1 ) \\ {\dot{y}}^{( t )} = softmax ( Vh \text{?} + c ) \\ {h}^{( t )} = tanh ( {Wh}^{( t - 1 )} + {Ux}^{( t )} + b ) & ( Equations 2 , 3 ) \\ \begin{matrix}parameter set \\ \{ W , U , V , b , c \}\end{matrix} \\ \text{?} \text{indicates text missing or illegible when filed} & ( Weighting parameter )\end{matrix}$$

There is a relationship in which a state of a current hidden layer is determined by the combination of a previous input value and a state of a previous hidden layer. While repeated computations are applied by applying a data set that has been originally known, there is an optimization problem that determines weight parameters, W, U, V, b, and c, which minimizes a loss function of Equation 1. Since all of these computations are matrix multiplication computations, high-dimensional vector matrices that are different from existing convolution computing units need to be multiplied.

Accordingly, in FIG. 13, a processor for RNN computation for this is illustrated. A recurrent network controller (RNC) 501 receives a control from an external control processor and receives and stores weighted vector values W, U, V, b, and c in a weight buffer 502 through a control signal CNTL-W and a bus Data-W, and loads information of an input value x(t) and a state h(t−1) of a previous hidden layer in an input buffer from Neuron (IBN) 503 as an input buffer. Thereafter, a matrix multiplier 504 for matrix multiplication computation receives an external control signal by a control of a flow controller 505 to perform a matrix multiplication computation and then transfers the matrix multiplication computation to an accumulation register 506. Here, the sum of matrix multiplication result computations is calculated, and an activation function block (AFB) 507 calculates a nonlinear activation result, such as tanh ( ) A state value of the current hidden layer is determined using the result value. In addition, after output values such as softmax are calculated, for next (t+1) computation, an output buffer to neuron (OBN) 508 feeds-back these output values to the input terminal.

Meanwhile, the embodiments of the present invention may be prepared by a computer executable program and implemented by a universal digital computer which operates the program by using a computer readable recording medium. The computer readable recording medium includes storage media such as magnetic storage media (e.g., a ROM, a floppy disk, a hard disk, and the like), optical reading media (e.g., a CD-ROM, a DVD, and the like), and a carrier wave (e.g., transmission through the Internet).

As described above, the present invention has an effect of reducing computation loads of the server by directly performing the distributed convolution computations in the device.

The present invention has been described above with reference to preferred embodiments thereof. It will be understood to those skilled in the art that the present invention may be implemented as a modified form without departing from an essential characteristic of the present invention. Therefore, the disclosed embodiments should be considered in an illustrative viewpoint rather than a restrictive viewpoint. The scope of the present invention is illustrated by the appended claims rather than by the foregoing description, and all differences within the scope of equivalents thereof should be construed as being included in the present invention.

1. A neural network processing unit for a device comprising:
an AV input matcher that receives a video signal or audio signal input from the outside;
a convolution computation controller which receives and buffers the video signal or audio signal from the AV input matcher, divides the video signal or audio signal into overlapping video segments according to a size of a convolution kernel, and transfers the divided data;
a convolution computation array which consists of a plurality of arrays, performs independent convolution computations for each divided video block by receiving the divided data, and transfers the results;
an active pass controller which receives feature map (FM) information as convolution computation results from the plurality of convolution computation arrays to transfer the FM information to the convolution computation controller again for subsequent convolution computations or perform activation determination and pooling computation on a neural network structure; and
a network processor for generating IP packets and processing TCP/IP or UDP/IP packets to transfer the FM as the convolution computation result to a server through a network and a control processor for installing and operating software for controlling configuration blocks.

2. The neural network processing unit for the device of claim 1, further comprising:
a codec capable of compressing a video or audio signal in real time, and transferring the compressed video or audio signal to the server without a delay together with event occurrence information, and a network processor for packet processing of the transferred information without a delay.

3. The neural network processing unit for the device of claim 1, wherein the each device processes the input video signal to an overlapped tile according to a size of a convolution kernel filter, and vertically and horizontally divides the tile, and convolution processes the divided tiles in parallel.

4. The neural network processing unit for the device of claim 1, further comprising:
a video data control unit that converts the video signal input through a video input interface into a data format which is easily manipulated therein, and temporarily stores the converted video signal in an external memory through an external memory controller connected to a high-speed bus through the high-speed bus;
an audio data control unit that receives the audio signal and temporarily stores in the external memory through the high-speed bus or transfers the audio signal to a 1D signal processing unit for slicing processing for a time;
a 2D data converting unit that receives internal converted data from the video data control unit and slices an image for convolution performing into multiple tile formats and then processes image slicing considering an overlapping part; and
the 1D signal processing unit that converts audio data received from the audio data control unit into a matrix for 1D processing.

5. The neural network processing unit for the device of claim 1, further comprising:
a convolution array that performs convolution computation processing for a 2D video input; and an RNN processor that simultaneously performs a matrix computation for time series data having temporal data such as an audio input signal.

6. The neural network processing unit for the device of claim 1, wherein multiple network processors are provided in order to feature map information obtained by a result of matrix computation processing for 1D audio information or a convolution computation for a 2D video signal to the server through a network without a delay to perform a function to TCP/IP and UDP/IP packets to a network side according to a protocol stack required for IP packetization processing.

7. The neural network processing unit for the device of claim 1, further comprising:
audio and video codecs that compress a selected image and an audio signal file in real time when a main event occurs or for storing the selected image and audio signal file in the server or other processing of the selected image and audio signal file and a dedicated processor that has with related firmware for real-time control mounted therein and drives a real-time compression algorithm.

8. The neural network processing unit for the device claim 1, wherein a current state is shown by a matrix multiplication of previous state information and a weight related thereto and a matrix multiplication of a current input value and a weight of a corresponding input, and a sum of initial weights, according to a constant sampling time displacement, and a current state and a future state are predicted by receiving a weight of a previous state, a weight of an input, and a weight vector value of a current state and processing the matrix multiplication, in a state transition relationship output by a weight multiplication of a current state value under the control by an external control processor.
